(19) United States
(12) Patent Application Publication
(10) Pub. No.: US 2022/0157008 A1
(43) Pub. Date: May 19, 2022

(54) CONTENT SOFTENING OPTIMIZATION

(71) Applicant: DATALOOP LTD., Herzliya (IL)

(72) Inventors: Eran SHLOMO, Zichron Yaakov (IL); Or SHABTAY, Tel-Aviv (IL); Avi YASHAR, Natanya (IL)

(21) Appl. No.: 17/526,153

(22) Filed: Nov. 15, 2021

Related U.S. Application Data
(60) Provisional application No. 63/114,089, filed on Nov. 16, 2020.

(51) Int. Cl. G06T 15/02; G06K 9/62

(52) U.S. Cl. CPC G06T 15/02; G06K 9/6267

(57) ABSTRACT

A computer-implemented method comprising: receiving, as input, a plurality of images, each associated with a specified content category; generating, from each of the plurality of images, a set of transformed images by applying a series of non-photorealistic transformations having escalating transformation degrees, wherein each of the transformed images is labeled with a label indicating (i) the transformation degree applied thereto, and (ii) a content category associated therewith; obtaining, with respect to each of the set of transformed images, classification results assigned by a human annotator, wherein the classification results assign each of the transformed images in the set into one of a plurality of content categories; and calculating, for the human annotator, a classification score in each of the plurality of content categories, based, at least in part, on all of the classification results.

### CROSS REFENCE TO RELATED APPLICATIONS

This application claims priority to U.S. Provisional Patent Application No. 63/114,089 filed on Nov. 16, 2020. The contents of this application are incorporated by reference in their entirety.

### BACKGROUND

The invention relates to the field of image processing.

Social media platforms such as Facebook, Twitter, and Instagram, regularly monitor content generated by their users. Users often upload offensive and non-compliant content conveying offensive, explicit, and/or other inappropriate material.

Human moderators are often employed in monitoring such content. However, it is well known that prolonged exposure to offensive content may lead to long-term psychological harm and negative social effects. Therefore, in recent years, there has been an effort to mitigate the emotional and psychological burden borne by human moderators exposed daily to such content.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive, as input, a plurality of images, each associated with a specified content category, generate, from each of the plurality of images, a set of transformed images by applying a series of non-photorealistic transformations having escalating transformation degrees, wherein each of the transformed images is labeled with a label indicating (i) the transformation degree applied thereto, and (ii) a content category associated therewith, obtain, with respect to each of the set of transformed images, classification results assigned by a human annotator, wherein the classification results assign each of the transformed images in the set into one of a plurality of content categories, and calculate, for the human annotator, a classification score in each of the plurality of content categories, based, at least in part, on all of the classification results.

There is also provided, in an embodiment, a computer-implemented method comprising: receiving, as input, a plurality of images, each associated with a specified content category; generating, from each of the plurality of images, a set of transformed images by applying a series of non-photorealistic transformations having escalating transformation degrees, wherein each of the transformed images is labeled with a label indicating (i) the transformation degree applied thereto, and (ii) a content category associated therewith; obtaining, with respect to each of the set of transformed images, classification results assigned by a human annotator, wherein the classification results assign each of the transformed images in the set into one of a plurality of content categories; and calculating, for the human annotator, a classification score in each of the plurality of content categories, based, at least in part, on all of the classification results.

There is further provided, in an embodiment, a computer program product comprising a non-transitory computer-readable storage medium having program instructions embodied therewith, the program instructions executable by at least one hardware processor to: receive, as input, a plurality of images, each associated with a specified content category; generate, from each of the plurality of images, a set of transformed images by applying a series of non-photorealistic transformations having escalating transformation degrees, wherein each of the transformed images is labeled with a label indicating (i) the transformation degree applied thereto, and (ii) a content category associated therewith; obtain, with respect to each of the set of transformed images, classification results assigned by a human annotator, wherein the classification results assign each of the transformed images in the set into one of a plurality of content categories; and calculate, for the human annotator, a classification score in each of the plurality of content categories, based, at least in part, on all of the classification results.

In some embodiments, each of the images is one of: a single image, a series of images, a video segment, and video live streaming.

In some embodiments, with respect to each of the images, each of the transformations represents at least one of: a softening of the image, a stylization of the image, an abstraction of the image, and a non-photorealistic rendering of the image.

In some embodiments, the plurality of transformation are selected from the group consisting of: color manipulation, line drawing, edge-preserving smoothing, contour transformations, edge detection and enhancement, tonal range modification, image-based artistic rendering.

In some embodiments, with respect to each of the transformed images, the transformation degree corresponds to the level of recognizability of a content of the transformed image.

In some embodiments, the calculating of the classification score is based on the highest the transformation degree of a transformed image in the set that is correctly assigned to its associated specified content category.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates an exemplary system for optimized softening, stylization, and/or abstraction of image content, to enable efficient annotation and/or classification by human annotators of the content, while minimizing harmful content exposure and diminishing affective response and emotional impact by the annotators, in accordance with some embodiments of the present invention;

FIG. 2 is a flowchart detailing the functional steps in a process for generating a dataset of softened, stylized, and/or abstracted image content, for use in conjunction with a process for evaluating human annotators for determining a maximal softening, stylization, and/or abstraction level associated with an individual annotator with respect to a content category, in accordance with some embodiments of the present invention;

FIG. 3 is a flowchart detailing the functional steps in an annotator evaluation process for determining a maximal softening, stylization, and/or abstraction level associated with an individual annotator with respect to a content category, in accordance with some embodiments of the present invention; and

FIGS. 4A-4C shows exemplary depiction of degrees of image transformations, in accordance with some embodiments of the present invention.

### DETAILED DESCRIPTION

Disclosed herein is a technique, embodied in a system, method, and computer program product, for optimized softening, stylization, and/or abstraction of image content, to enable efficient annotation and/or classification by human annotators of the content, while minimizing harmful content exposure and diminishing affective response and emotional impact by the annotators. In some embodiments, the image content may be in the form of a single image, a series of images, a video segment, video live streaming, and the like.

In some embodiments, the present technique may be particularly useful in the context of moderating user-generated content by media and social media platforms, to mitigate exposure to strong image content by human annotators. User-generated content is defined as image content included in a wide variety of online media and social media formats, such as blogs, newspaper articles, discussion forum posts, newsgroup posts, chat messages, personal or direct messages, e-mails, tweets, podcasts, advertisements, uploaded video segments, and/or other forms of media. User-generated content is often published via social media accounts or other websites, to a defined group of people or to the greater public.

While many types of internet websites allow for publication of user-generated content, most websites employ moderators and/or administrators to monitor at least part of the user-generated content uploaded thereto, to remove offensive, explicit, non-compliant, illegal, and similar content.

Content moderation is a process of eliminating or lessening extremes. It is used to ensure acceptability throughout the medium on which it is being conducted. The term ‘moderation’ is used herein generally to a process by which a human reviewer generates an indication of or guidance as to whether the content analyzed is unacceptable in view of the particular standards of the relevant platform. A moderator working within the context of a public platform may remove unsuitable contributions, e.g., remove completely or reduce the excessiveness of a content, in order to make it less violent, severe, intense, obscene, illegal, or offensive with regards to useful or informative contributions.

To effectively perform their duties, moderators must personally view—and be able to perceive and recognize—media content. However, as noted, prolonged exposure by human moderators to explicit, obscene, and/or offensive content may emotionally impact and negatively affect the well-being of these key employees of the enterprise. Thus, enterprises have been employing various image processing methods for ‘softening’ harsh material in a manner that seeks to mitigate its explicit nature, while still allowing for adequate discerning of the content, to allow for correct classification. However, image softening may be performed at different levels of abstraction, and annotators may differ in their ability to discern and perceive content, depending on the content category and level of softening and/or abstraction.

Accordingly, in some embodiments, the present disclosure provides for optimized softening, stylization, and/or abstraction of image content, to enable efficient annotation and/or classification by human annotators of the content, while minimizing harmful content exposure and diminishing affective response and emotional impact by the annotators.

In some embodiments, the present technique may provide for learning an optimized assignment of content categories to individual annotators, based on determining a maximal softening, stylization, and/or abstraction level that is suitable for each individual annotator with respect to each content category.

In some embodiments, determining a maximal softening, stylization, and/or abstraction level associated with an individual annotator with respect to a content category, may be performed by presenting an individual annotator with content in a specified content category, wherein the content may be transformed using a series of escalating softening, stylization, and/or abstraction transformations. For example, in some embodiments, an annotator may be presented with a series of escalating transformations of image content in a specified content category, wherein each transformation represents an escalating degree of softening, stylization, and/or abstraction. The annotator may be asked to annotate the series of image content, e.g., to classify the image content into two or more provided categories. The annotator may then be assigned a score which represents the maximal level of softening, stylization, and/or abstraction at which that annotator is still able to correctly classify the content presented in that specified category. This process may be repeated with respect to additional content categories, until a scoring matrix is obtained with respect to the annotator, representing a score with respect to each content category.

In the context of an enterprise annotating scheme comprising multiple annotators, e.g., at a social media platform, such scoring matrices may be used to determine optimized assignment of annotating tasks to individual annotators within the enterprise, based on content categories, so as to efficiently assign to each annotator content within categories in which that annotator is bale to classify the content at a relatively higher level of softening, stylization, and/or abstraction, to thus minimize exposure to harmful content among all annotators.

A potential advantage of the present disclosure is, therefore, in that it provides for a reduction in exposure to by human annotators to harmful content, without minimal effect on content efficiency, accuracy, and speed.

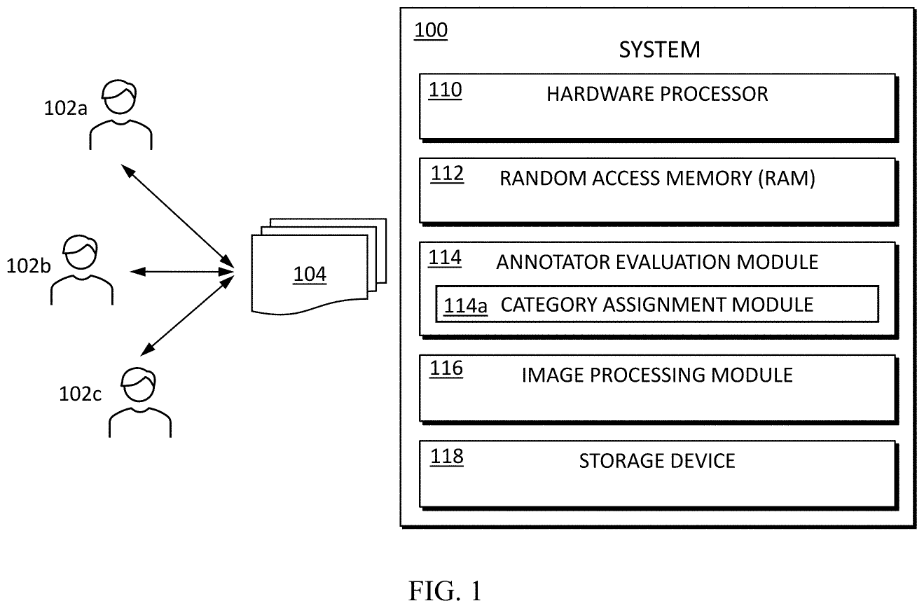

FIG. 1 illustrates an exemplary system 100 for optimized softening, stylization, and/or abstraction of image content, to enable efficient annotation and/or classification by human annotators of the content, while minimizing harmful content exposure and diminishing affective response and emotional impact by the annotators, in accordance with some embodiments of the present invention.

System 100 as described herein is only an exemplary embodiment of the present invention, and in practice may have more or fewer components than shown, may combine two or more of the components, or a may have a different configuration or arrangement of the components. The various components of system 100 may be implemented in hardware, software or a combination of both hardware and software. In various embodiments, system 100 may comprise a dedicated hardware device, or may be implement as a hardware and/or software module into an existing device.

System 100 may include one or more hardware processor(s) 110, a random-access memory (RAM) 112, and one or more non-transitory computer-readable storage device(s) 118. Components of system 100 may be co-located or distributed, or the system may be configured to run as one or more cloud computing ‘instances,’ ‘containers,’ ‘virtual machines,’ or other types of encapsulated software applications, as known in the art.

Storage device(s) 118 may have stored thereon program instructions and/or components configured to operate hardware processor(s) 110. The program instructions may include one or more software modules, such as an annotator evaluation module 114, comprising, e.g., category assignment module 114a; and image processing module 116. The software components may include an operating system having various software components and/or drivers for controlling and managing general system tasks (e.g., memory management, storage device control, power management, etc.), and facilitating communication between various hardware and software components. System 100 may operate by loading instructions of the various software modules 114, 114a, and The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls. into RAM 112 as they are being executed by processor(s) 110.

In some embodiments, system 100 may be implemented in the context of user content moderation by media and social media platforms, for the purpose of optimized assignment of content categories to individual annotators and/or moderators 102a-102c based on determining a maximal softening, stylization, and/or abstraction level associated with an individual annotator with respect to each content category associated with content items 104. In some embodiments, system 100 may be configured for optimized assignment of content items 104 based, at least in part, on a learning process of the maximal softening, stylization, and/or abstraction level associated with each individual annotators 102a-102c with respect to each content category.

As used herein, the term “image” broadly refers to any type of visually perceptible content that may be rendered, e.g., on a display monitor or a print medium. Images may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image.

The terms “content” or “content item” or “image content” as used herein refers broadly to any media content comprising, e.g., a single image, a series of images, a video segment, video live streaming, and the like.

The term “techniques” may refer to systems, methods, computer-readable instructions, modules, algorithms, hardware logic and/or operations as permitted by the context described throughout this document.

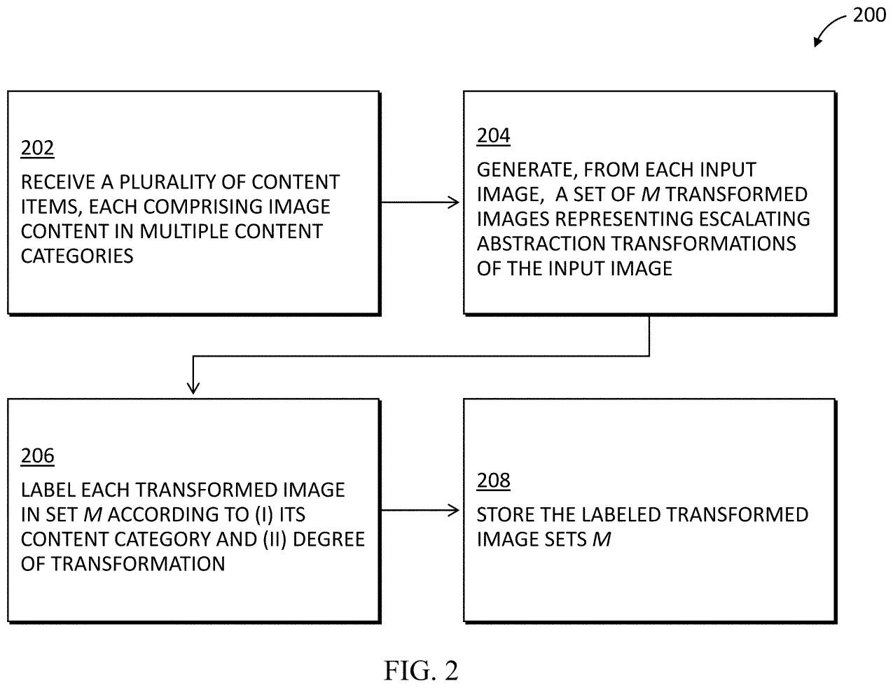

FIG. 2 is a flowchart detailing the functional steps in a method 200 for generating a dataset of softened, stylized, and/or abstracted image content, for use in conjunction with a process for evaluating human annotators for determining a maximal softening, stylization, and/or abstraction level associated with an individual annotator with respect to a content category, in accordance with some embodiments of the present invention.

The various steps of method 200 may either be performed in the order they are presented or in a different order (or even in parallel), as long as the order allows for a necessary input to a certain step to be obtained from an output of an earlier step. In addition, the steps of method 200 may be performed automatically (e.g., by system 100 of FIG. 1), unless specifically stated otherwise.

In some embodiments, in step 202, the instructions of image processing module 116 may cause system 100 to receive and store (e.g., on storage device 118) one or more content items, e.g., content items 104 (shown in FIG. 1), each comprising image content, e.g., one or more images, series of images, video segments, etc.

In some embodiments, the content items 104 may each include content that is associated with one or more categories which are subject to content moderation, e.g., explicit content, violent content, offensive content, illegal content, and the like.

In some embodiments, in step 204, the instructions of image processing module 116 may cause system 100 to generate, from each input image within content items 104, a set of m transformed images representing escalating abstraction transformations of the input image. In some embodiments, image processing module 116 may be configured to apply one or more image processing techniques, methods, and/or algorithms, to transform image content included in each of the content items 104, based on one or more softening, stylization, and/or abstraction processes. In some embodiments, image processing module 116 may employ any number of existing or known image processing methods, which may be implemented in software and/or hardware, for performing the required image transformations.

In some embodiments, the possible image transformation performed by image processing module 116 may comprise a set of various image transformations of the input content, each representing varying, differing, and/or escalating degree and/or gradations of softening, stylization, and/or abstraction of image content, relative to the original content. In some embodiments, each such degree of softening, stylization, and/or abstraction may represent, with respect to an image, a corresponding degree of recognizability of the original content, e.g., from most to least recognizable. In some embodiments, a degree of recognizability of a specified transformation may be annotator-dependent, wherein different human annotators may differ in their ability to discern and perceive content, depending on the content category and level of softening and/or abstraction.

In some embodiments, a result of step 204 may be an output set comprising a plurality of transformed content items 104, wherein each transformed content item represents a stylistic, non-photorealistic, and/or expressive rendering of the original content item 104.

As used herein, the terms “softening,” “stylization,” and/or “abstraction” refer to processing techniques as well as any procedure that transforms an image into another image, while keeping it at least partially recognizable. The terms softening, stylization, and/or abstraction may be used interchangeably and refer to any application or process of stylistic, non-photorealistic, and/or expressive filtering and/or rendering techniques which perform stylization of images or videos, in order to modify a way in which the content of the image or video is perceived and experienced by humans. In some embodiments, these processes and transformations diminish, reduce, and/or mitigate affective response and emotional impact in a viewer, but retain recognizability to allow for content classification.

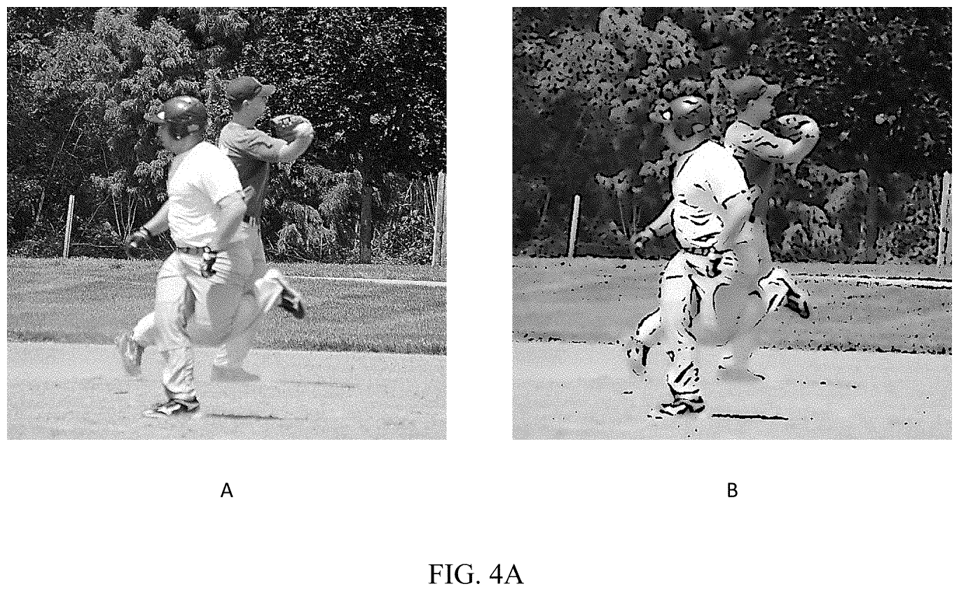

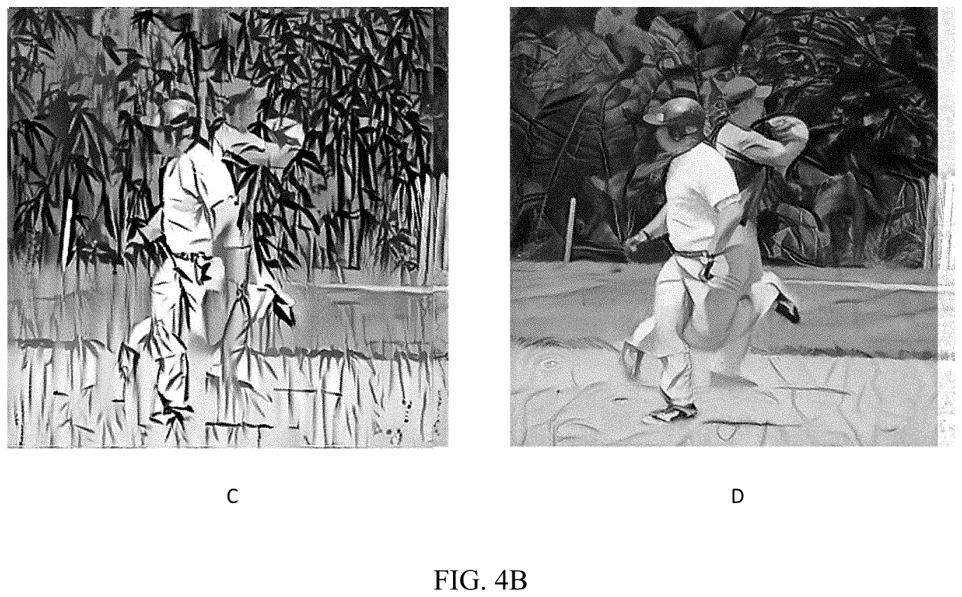

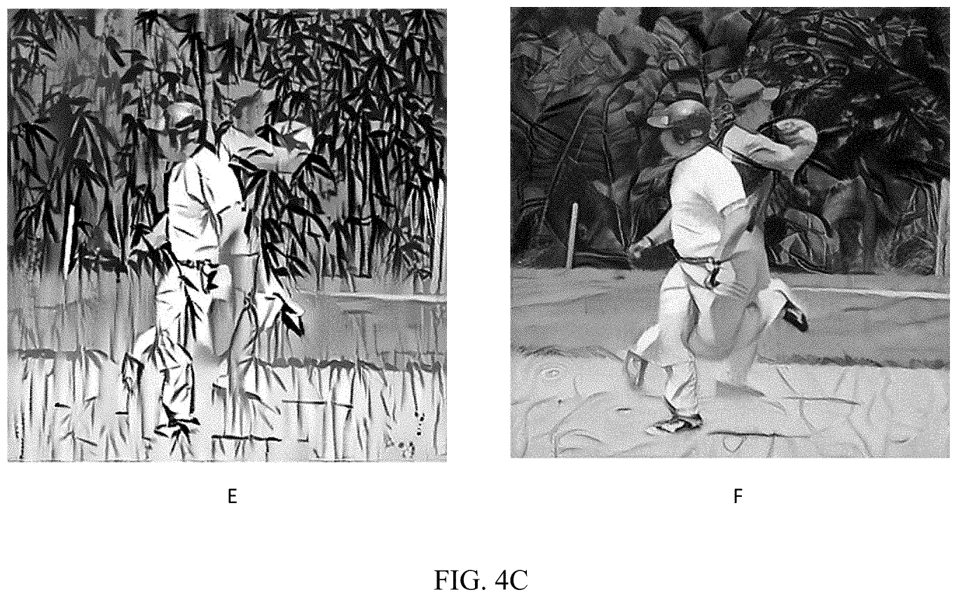

An exemplary depiction of escalating degrees of image transformations is shown in FIGS. 4A-4C, where panel A is an original image, and panels B-F are increasingly escalating transformations applied to the original image, respectively.

In some embodiments, the transformation techniques which may be used by image processing module 116 may include one or more of:
Color manipulation,
tonal range modification,
edge-preserving smoothing,
contour transformations,
transformation into line drawings,
edge detection and enhancement, and
image-based artistic rendering.

However, any additional and/or different techniques which may transform an image into another image while keeping it at least partially recognizable, and modify a way in which the content of the image or video is perceived and experienced by humans, may be considered within the context of the present disclosure.

Image decolorization and re-colorization may include any modification to a tonal range, transformation into a different color palette (e.g., grayscale) in an optimized manner so as to preserve salient features, e.g., by quantifying color differences between image locations or prevailing chromatic contrasts, optimizing color and luminance contrasts, or considering the Helmholtz-Kohlrausch color appearance effect. Color manipulation may reduce the emotional impact of certain items, e.g., the appearance of blood, etc.

Edge-preserving image smoothing algorithms may be used to smooth details without filtering significant image structures. Edge detection and enhancement may be used to ease object recognition.

Artistic image stylization may be used to dampen emotional responses, by simulating traditional media and painting techniques found in illustrative visualization, e.g., watercolor, oil paint, pen-and-ink, and stippling.

In some embodiments, in step 206, each transformed image generated in step 204 may be labeled. Accordingly, in some embodiments, step 206 comprises the following stages:
Define a dataset X comprising N images {X₀, X₁ . . . Xₙ}, and
create, for each image in dataset X, e.g., image X₀, a set of M transformed images {X₀₋₁, X₀₋₂ . . . X₀₋ₘ} using transformation degrees from a set [0 . . . m], wherein transformation degree m represent the highest degree of softening, stylization, and/or abstraction.

Each transformed image in dataset X is labeled with its corresponding transformation degree [0 . . . m] as well as with its content category [k₁ . . . kₙ] from a set of k content categories.

In some embodiments, in step 208, dataset X including the original images as well as all the transformed and labeled images, may be stored by system 100, e.g., on storage device 118.

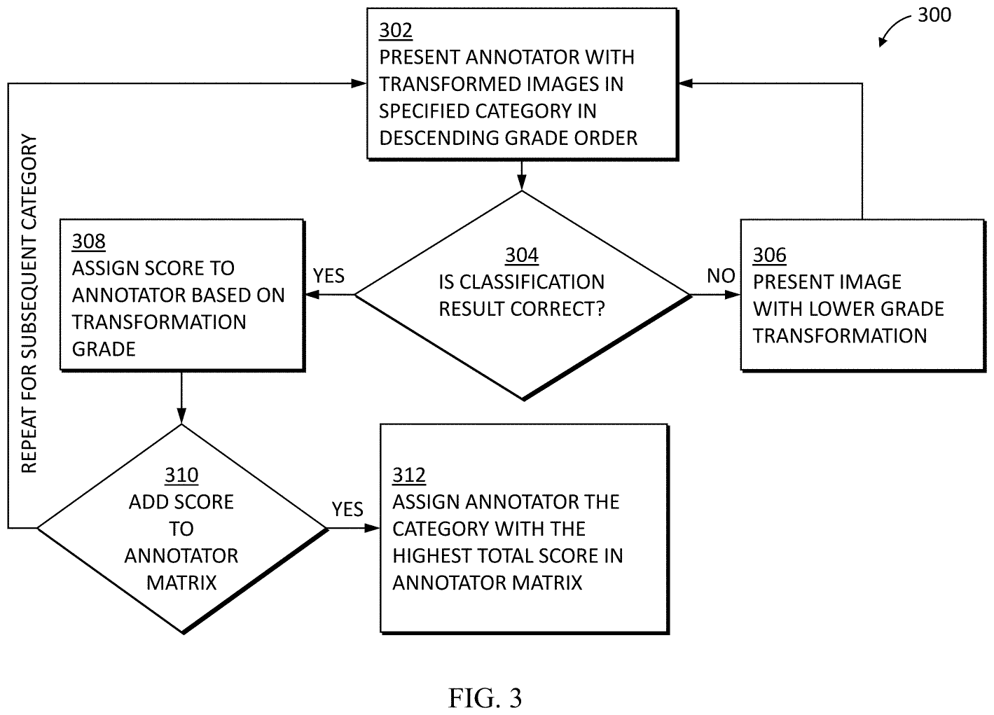

FIG. 3 is a flowchart detailing the functional steps in an annotator evaluation method 300 for determining a maximal softening, stylization, and/or abstraction level associated with an individual annotator with respect to a content category, in accordance with some embodiments of the present invention.

In some embodiments, in step 302, the instructions of annotator evaluation module 114 (shown in FIG. 1) may cause system 100 to present to an annotator under evaluation, e.g., one of annotators 102a-102c, an initial image from a set {Xᵢ₋₀, Xᵢ₋₁ . . . Xᵢ₋ₘ} (104 in FIG. 1) comprising an original image Xᵢ and its corresponding transformation, in a first content category k₁, wherein the series of images may represent escalating transformations using a series of escalating softening, stylization, and/or abstraction transformations degree from a set [0 . . . m], as detailed above with reference to FIG. 2.

Accordingly, in some embodiments, in step 302, the annotator may be presented with an initial image from set {Xᵢ₋₀, Xᵢ₋₁ . . . Xᵢ₋ₘ} within a content category k₁ for classification by the annotator under evaluation into one of content categories [k₁ . . . k ₙ]. In some embodiments, the initial image may be selected as the image representing the highest degree of transformation from among the set {Xᵢ₋₀, Xᵢ₋₁ . . . Xᵢ₋ₘ}, e.g., image Xᵢ₋ₘ. In some embodiments, the initial image may be selected as the image representing the lowest degree of transformation from among the set {Xᵢ₋₀, Xᵢ₋₁ . . . Xᵢ₋ₘ}, e.g., original image Xᵢ₋₀. In yet other embodiments, the initial image may be randomly selected from set {Xᵢ₋₀, Xᵢ₋₁ . . . Xᵢ₋ₘ}.

In some embodiments, in step 304, the instructions of annotator evaluation module 114 (shown in FIG. 1) may cause system 100 to perform an evaluation of the correctness of the classification of the initial image, i.e., whether the classification of the initial image is consistent with its actual content category k₁.

If the classification result does not match the content category k₁ of the image, then in step 306, one or more subsequent images may be iteratively present to the annotator under evaluation from the set {Xᵢ₋₀, Xᵢ₋₁ . . . Xᵢ₋ₘ}. In the case presented in FIG. 3, the subsequent images are presented in a descending order of transformations, i.e., each subsequent image represents a generally more recognizable transformation level than the immediately preceding image, e.g., Xᵢ₋ₘ→Xᵢ₋ₘ₋₁ . . . →Xᵢ₋₀. In the case that the initial image was selected as the image representing the lowest degree of transformation from among the set {Xᵢ₋₀, Xᵢ₋₁ . . . Xᵢ₋ₘ}, the subsequent images are presented in an ascending order of transformations, i.e., each subsequent image represents a generally less recognizable transformation level than the immediately preceding image, e.g., Xᵢ₋₀→Xᵢ₋₁ . . . →Xᵢ₋ₘ. In the case that the initial image is randomly selected from set {Xᵢ₋₀, Xᵢ₋₁ . . . Xᵢ₋ₘ}, each subsequent image may also be randomly selected.

In step 308, upon correct classification by the annotator under evaluation of an initial or a subsequent transformed image having a specified transformation degree, the instructions of annotator evaluation module 114 may cause system 100 to assign a score associated with the respective transformation degree of the successfully-classified image to the annotator under evaluation, with respect to the content category k₁ of the classified image.

In some embodiments, the instructions of annotator evaluation module 114 (shown in FIG. 1) may cause system 100 to repeat the process of steps 302-308 with respect to a subsequent content category k₂, wherein the instructions of annotator evaluation module 114 (shown in FIG. 1) may cause system 100 to present to an annotator under evaluation an initial image from a subsequent set {X₁₋₀, Xⱼ₋₁ . . . Xⱼ₋ₘ} comprising an original image Xⱼ and its corresponding transformations, in a specified content category k₂. Steps 302-308 may then repeat with respect to additional or all content categories within set [k₁ . . . kₙ]until the annotator under evaluation has a score assigned with respect to each content category [k₁ . . . kₙ].

In some embodiments, in step 310, once the iterative process of step 308 has concluded, the instructions of annotator evaluation module 114 (shown in FIG. 1) may cause system 100 to generate a scoring matrix for the annotator under evaluation, with a category score representing the highest transformation degree which the annotator under evaluation has been able to correctly classify in each content category. For example, a final score matrix for an annotator under evaluation may be represented as:

ANNOTATOR

| CONTENT CATEGORY | CONTENT CATEGORY SCORE |
|---|---|
| k₁ | 8 |
| k₂ | 2 |
| k₃ | 3 |
| k₄ | 7 |
| k₅ | 9 |
| k₆ | 5 |
| . . . | |
| Kₙ | 8 |

In some embodiments, the instructions of category assignment module 114a (shown in FIG. 1) may cause system 100 to assign to the annotator under evaluation one or more content categories for ongoing classification of user-generated image content, wherein the assigned one or more content categories correspond to a maximal image transformation degree for which the annotator successfully classified a transformed image in the assigned content category. In the example shown above, the annotator degree may be 9 assigned with respect to content category k₅.in other examples, an annotator may be assigned one or more content categories wherein the annotator has been assigned a score above a minimum threshold, e.g., any category having a score above 6.

This enables subsequent classification assignments of image content with the content category assigned to the annotator to be presented to the annotator at an optimal transformation grade, thus reducing content exposure, while maintaining a high probability of classification accuracy.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
at least one hardware processor; and
a non-transitory computer-readable storage medium having stored thereon program instructions, the program instructions executable by the at least one hardware processor to:
receive, as input, a plurality of images, each associated with a specified content category,
generate, from each of said plurality of images, a set of transformed images by applying a series of non-photorealistic transformations having escalating transformation degrees, wherein each of said transformed images is labeled with a label indicating (i) said transformation degree applied thereto, and (ii) a content category associated therewith,
obtain, with respect to each of said set of transformed images, classification results assigned by a human annotator, wherein said classification results assign each of said transformed images in said set into one of a plurality of content categories, and
calculate, for said human annotator, a classification score in each of said plurality of content categories, based, at least in part, on all of said classification results.

2. The system of claim 1, wherein each of said images is one of: a single image, a series of images, a video segment, and video live streaming.

3. The system of claim 1, wherein, with respect to each of said images, each of said transformations represents at least one of: a softening of said image, a stylization of said image, an abstraction of said image, and a non-photorealistic rendering of said image.

4. The system of claim 1, wherein said plurality of transformation are selected from the group consisting of: color manipulation, line drawing, edge-preserving smoothing, contour transformations, edge detection and enhancement, tonal range modification, image-based artistic rendering.

5. The system of claim 1, wherein, with respect to each of said transformed images, said transformation degree corresponds to the level of recognizability of a content of said transformed image.

6. The system of claim 5, wherein said calculating of said classification score is based on the highest said transformation degree of a transformed image in said set that is correctly assigned to its associated specified content category.

7. A computer-implemented method comprising:
receiving, as input, a plurality of images, each associated with a specified content category;
generating, from each of said plurality of images, a set of transformed images by applying a series of non-photorealistic transformations having escalating transformation degrees, wherein each of said transformed images is labeled with a label indicating (i) said transformation degree applied thereto, and (ii) a content category associated therewith;
obtaining, with respect to each of said set of transformed images, classification results assigned by a human annotator, wherein said classification results assign each of said transformed images in said set into one of a plurality of content categories; and
calculating, for said human annotator, a classification score in each of said plurality of content categories, based, at least in part, on all of said classification results.

8. The computer-implemented method of claim 7, wherein each of said images is one of: a single image, a series of images, a video segment, and video live streaming.

9. The computer-implemented method of claim 7, wherein, with respect to each of said images, each of said transformations represents at least one of: a softening of said image, a stylization of said image, an abstraction of said image, and a non-photorealistic rendering of said image.

10. The computer-implemented method of claim 7, wherein said plurality of transformation are selected from the group consisting of: color manipulation, line drawing, edge-preserving smoothing, contour transformations, edge detection and enhancement, tonal range modification, image-based artistic rendering.

11. The computer-implemented method of claim 7, wherein, with respect to each of said transformed images, said transformation degree corresponds to the level of recognizability of a content of said transformed image.

12. The computer-implemented method of claim 11, wherein said calculating of said classification score is based on the highest said transformation degree of a transformed image in said set that is correctly assigned to its associated specified content category.

13. A computer program product comprising a non-transitory computer-readable storage medium having program instructions embodied therewith, the program instructions executable by at least one hardware processor to:
receive, as input, a plurality of images, each associated with a specified content category;
generate, from each of said plurality of images, a set of transformed images by applying a series of non-photorealistic transformations having escalating transformation degrees, wherein each of said transformed images is labeled with a label indicating (i) said transformation degree applied thereto, and (ii) a content category associated therewith;
obtain, with respect to each of said set of transformed images, classification results assigned by a human annotator, wherein said classification results assign each of said transformed images in said set into one of a plurality of content categories; and
calculate, for said human annotator, a classification score in each of said plurality of content categories, based, at least in part, on all of said classification results.

14. The computer program product of claim 13, wherein each of said images is one of: a single image, a series of images, a video segment, and video live streaming.

15. The computer program product of claim 13, wherein, with respect to each of said images, each of said transformations represents at least one of: a softening of said image, a stylization of said image, an abstraction of said image, and a non-photorealistic rendering of said image.

16. The computer program product of claim 13, wherein said plurality of transformation are selected from the group consisting of: color manipulation, line drawing, edge-preserving smoothing, contour transformations, edge detection and enhancement, tonal range modification, image-based artistic rendering.

17. The computer program product of claim 13, wherein, with respect to each of said transformed images, said transformation degree corresponds to the level of recognizability of a content of said transformed image.

18. The computer program product of claim 17, wherein said calculating of said classification score is based on the highest said transformation degree of a transformed image in said set that is correctly assigned to its associated specified content category.
